(19) United States
(12) Patent Application Publication
(10) Pub. No.: US 2006/0171358 A1
(43) Pub. Date: Aug. 3, 2006

(54) Downlink data optimization for packet switched handover

(75) Inventors: Arto Ta Kangas, Espoo (FI); Tapani Virtanen, Espoo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/095,312

(22) Filed: Mar. 21, 2005

Related U.S. Application Data
(60) Provisional application No. 60/647,950, filed on Jan. 28, 2005.

(51) Int. Cl. H04Q 7/00

(52) U.S. Cl. 370/331

(57) ABSTRACT

This invention describes a methodology for improving the performance of downlink data transfer during handovers of packet switched connections by informing the SGSN about a cell change and reducing the service interruption during the cell change. Compared to the existing procedure described in the 3GPP TS 43.129 V6. 1.0 (2004-11), the present invention eliminates the need for a cell update and a flush procedure.

### CROSS-REFERENCE TO RELATED APPLICATION

This application claims priority from U.S. Provisional Patent Application Ser. No. 60/647,950, filed Jan. 28, 2005.

### FIELD OF THE INVENTION

The present invention relates to global system for mobile communications (GSM) and more specifically to optimization of downlink data transfer during handovers of packet switched connections.

### BACKGROUND ART

The standardization of packet switched handover is ongoing, e.g., on 3GPP Technical Specification Group GERAN (GSM/EDGE radio access network). Currently a packet switched handover of an optimized intra-BSS (base station subsystem) handover case is defined in stage 2 document 3GPP TS 43.129 V6.0.0 (2004-11) “Packet-Switched Handover for GERAN A/Gb mode”. In that case the SGSN (serving GPRS support node, wherein GPRS stands for general packet radio service) does not participate on the actual handover, but still a cell update and flush procedure is needed to restart the transmission on downlink on the target cell.

The problem is that during a packet switched handover the continuation of downlink data transmission is delayed because the SGSN waits for the cell update from a mobile station (MS) and after that a flush procedure has to be performed by the SGSN in order to know the situation on the actual data flow. The restart of a downlink transmission on the target cell starts currently after cell update (step 40) and flush procedures (steps 42a and 42b), as shown in FIG. 2, which presents the optimized intra-BSS case as an example. The procedure of FIG. 2 is based on the current version of the stage two document 3GPP TS 43.129 V6.1.0 (2004-11) as discussed in more detail below.

### DISCLOSURE OF THE INVENTION

The object of the present invention is to provide a method for improving the performance of downlink data transfer during handovers of packet switched connections specifically, e.g., by eliminating a need for a cell update and a flush procedure.

According to a first aspect of the invention, a method for improving the performance of a downlink data transfer during a packet switched handover, comprises: changing a source cell to a target cell in a context of the packet switched handover; and informing a serving general packet radio service (GPRS) support node about the cell change right after the change, which allows starting immediately the downlink data transfer, thus reducing a service interruption caused by the packet switched handover.

According further to the first aspect of the invention, the method may further comprise the step of: informing a mobile station (MS) about the cell change right after the change, which allows starting immediately an uplink data transfer, thus further reducing the service interruption caused by the packet switched handover.

Further according to the first aspect of the invention, the changing the source cell to the target cell may be performed by a base station subsystem using a normal communication with a mobile station. Further, the informing the serving general packet radio service (GPRS) support node about the cell change may be performed by the base station subsystem, and after the informing the mobile station may not perform a cell update procedure. Still further, after informing the serving general packet radio service (GPRS) support node about the cell change, flush procedures are not performed.

Still further according to the first aspect of the invention, the informing may be performed by a base station subsystem.

According further to the first aspect of the invention, the packet switched handover may correspond to an optimized intra-BSS procedure.

According still further to the first aspect of the invention, the packet switched handover may correspond to a non-optimized intra-BSS procedure.

According further still to the first aspect of the invention, the packet switched handover may correspond to an inter-BSS procedure.

According yet further still to the first aspect of the invention, the packet switched handover may be performed within a GSM/EDGE radio access network.

According to a second aspect of the invention, a computer program product comprises: a computer readable storage structure embodying computer program code thereon for execution by a computer processor with the computer program code characterized in that it includes instructions for performing the steps of the first aspect of the invention indicated as being performed by any component or a combination of components of the base station subsystem, the mobile station, or the serving general packet radio service (GPRS) support node.

According to a third aspect of the invention, a system for improving the performance of a downlink data transfer during a packet switched handover, comprises: a base station subsystem, for changing a source cell to a target cell in a context of the packet switched handover and for informing about the cell change right after the change; and a serving general packet radio service (GPRS), responsive to the informing such that this allows starting immediately the downlink data transfer, thus reducing a service interruption caused by the packet switched handover.

According further to the third aspect of the invention, the changing the source cell to the target cell may be performed by a base station subsystem using a normal communication with a mobile station. Further, the informing the serving general packet radio service (GPRS) support node about the cell change may be performed by the base station subsystem, and after the informing the mobile station may not perform a cell update procedure. Still further, after informing the serving general packet radio service (GPRS) support node about the cell change, flush procedures maynot performed.

Further according to the third aspect of the invention, the informing may be performed by a base station subsystem.

Still further according to the third aspect of the invention, the packet switched handover may correspond to an optimized intra-BSS procedure or a non-optimized intra-BSS procedure.

According further to the third aspect of the invention, the packet switched handover may correspond to an inter-BSS procedure.

According still further to the third aspect of the invention, the packet switched handover may be performed within a GSM/EDGE radio access network.

According yet further still to the third aspect of the invention, the base station subsystem may be for further forwarding downlink data from the source cell to the target cell and for releasing radio resources in the source cell right after the cell change, which may allow starting immediately the downlink data transfer, thus reducing the service interruption caused by the packet switched handover.

According to a fourth aspect of the invention, a base station subsystem for improving the performance of a downlink data transfer during a packet switched handover, comprises: means for changing a source cell to a target cell in a frame of the packet switched handover; means for informing a serving general packet radio service (GPRS) support node about the cell change right after the change, which allows starting immediately the downlink data transfer, thus reducing a service interruption caused by the packet switched handover.

According further to the fourth aspect of the invention, the base station may further comprise: means for forwarding downlink data from the source cell to the target cell and for releasing radio resources in the source cell right after the cell change, which allows starting immediately the downlink data transfer, thus reducing the service interruption caused by the packet switched handover.

The benefits of the present invention include:
A downlink transmission gap is minimized after a packet switched handover.
An uplink transmission gap is minimized if a dummy LLC (logical link control) frame is used to perform a cell update.

### BRIEF DESCRIPTION OF THE DRAWINGS

For a better understanding of the nature and objects of the present invention, reference is made to the following detailed description taken in conjunction with the following drawings, in which:

FIG. 1 is a block diagram demonstrating a communication system environment for implementing a packet switched handover according to the present invention;

FIG. 2 is a flow diagram illustrating a packet switched handover procedure based on a stage 2 document 3GPP TS 43.129 V6.1.0 (2004-11) for an optimized intra-BSS case, according to the prior art; and

FIG. 3 is a flow diagram illustrating a packet switched handover for an optimized intra-BSS case, according to the present invention.

### BEST MODE FOR CARRYING OUT THE INVENTION

The present invention provides a methodology for improving the performance of downlink (DL) data transfer during handovers of packet switched connections by informing the SGSN (serving GPRS support node, wherein GPRS stands for a general packet radio service) about a cell change and reducing the service interruption during the cell change. Furthermore, compared to the existing procedure described in the 3GPP TS 43.12 V6.1.0 (2004-11), the present invention eliminates the need for a cell update and a flush procedure as discussed below in detail. The present invention can be applied to GERAN (GSM/EDGE radio access network).

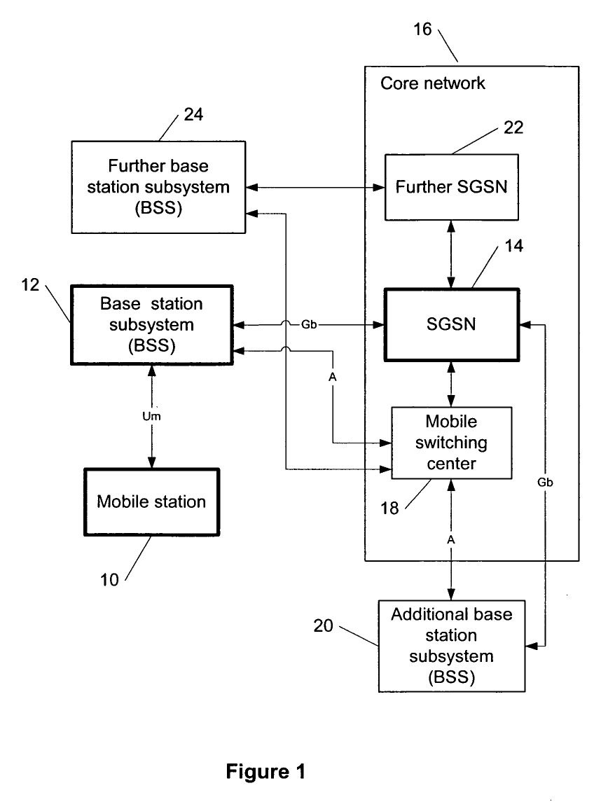

FIG. 1 shows one example among others of a block diagram demonstrating a communication system environment for implementing a packet switched handover in GERAN A/Gb mode, according to the present invention. It shows a mobile station (MS) 10 communicating with a base station subsystem (BSS) 12 through a Um interface. The BSS 12 is communicating with a SGSN 14 and a mobile switching center (MSC) 18 of a core network 16 through interfaces Gb and A, respectively. Also FIG. 1 shows an additional base station (BSS) 20 communicating with the same SGSN 14 and the MSC 18 through the interfaces Gb and A, respectively. A further SGSN 22 of the core network 16 and a further BSS 24, communicating with the SGSN 22 and the MSC center 18, are show in FIG. 1 as well.

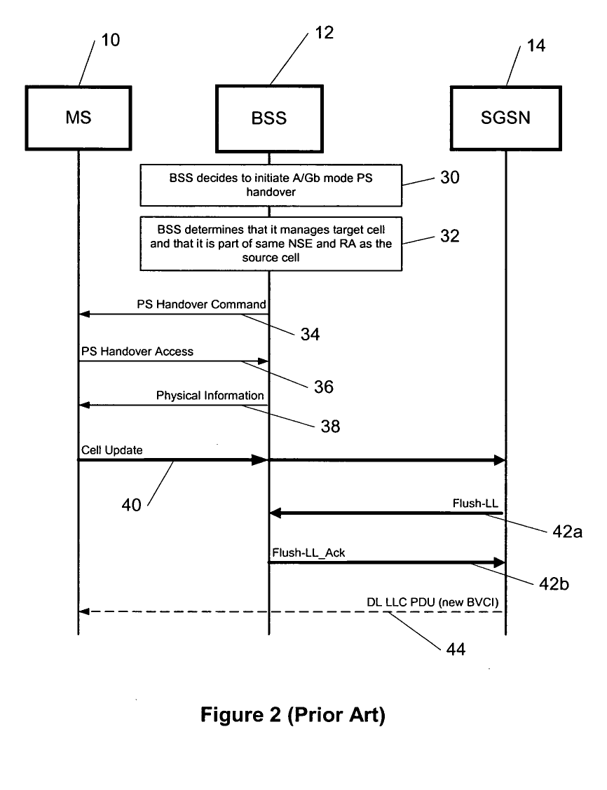

FIG. 2 is an example among others of a flow diagram illustrating a packet switched handover procedure based on the stage 2 document 3GPP TS 43.129 V6.1.0 (2004-11) for an optimized intra-BSS case, according to the prior art. For the optimized intra BSS case the source and target cells are associated with the same network service entity (NSE) and the same routing area (RA). In step 30 shown in FIG. 2, the BSS 12 decides that a handover is required based on received measurement reports. In step 32, the BSS 12 determines that it manages resources for both cells (target and source cells) and that they are associated with the same NSE and the same RA. In step 34, the BSS 12 sends the PS Handover Command message to the MS 10. In a step 36, the MS 10 tunes to the radio channel and the timeslot allocated in the target cell by the BSS 12 and sends the PS Handover Access (Handover Reference) message in the form of four handover access bursts) to the BSS 12 on the allocated channel. In a step 38, the BSS 12 sends a Physical Information message to the MS 10 for synchronization.

In a step 40, the MS sends an arbitrary LLC frame to the SGSN 14, which in the SGSN is interpreted as an implicit cell update. To make the handover interruption short the MS sends this message immediately after receiving the Physical Information message in step 38 or, in the synchronized network case, immediately after the sending of the PS Handover Access message of step 36. Upon reception of the first correct RLC/MAC (radio link control/medium access control) block (sent in a normal burst format) from the MS 10, the BSS 12 releases the radio resources in the source cell. The reception of the Cell Update message at the SGSN 14 triggers the sending of downlink data to the new cell using a new BVCI (BSSGP virtual connection identifier, wherein BSSGP stands for a base station subsystem GPRS protocol) if it is addressed by a different BVCI (as discussed below).

Next steps 42a and 42b relates to the flush procedure mentioned above. In a step 42a, the SGSN 14 responds to the Cell Update with a FLUSH-LL message. In a step 42b, the BSS 12 returns the FLUSH-LL_ACK message indicating if unsent LLC PDUs (logical link control/protocol data unit) have been deleted or transferred to a new cell. Finally, in a step 44, the first DL (downlink) PDU received by the BSS with the new-BVCI allows the BSS 12 to clear the relationship to the old BVCI.

More detailed description of steps 30 through 44 described above can be found in the stage 2 document 3GPP TS 43.129 V6.1.0 (2004-11), section 5.1.2.4 which is incorporated here by reference.

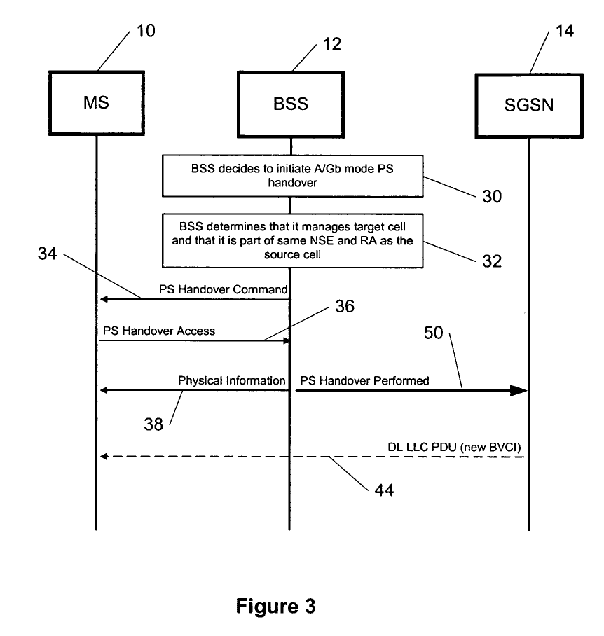

FIG. 3 is an example among others of a flow diagram illustrating a packet switched handover for an optimized intra-BSS case, according to the present invention. Steps 30-38 and 44 are the same as in the prior art FIG. 2. The major difference with the prior art of FIG. 2 is that steps 40, 42a and 42b are omitted, according to the present invention, as demonstrated in FIG. 3.

Since the BSS 12 (i.e., a base station controller (BSC) of the BSS 12, not shown in FIG. 1) selects the target cell, it is logical and beneficial that it also informs the SGSN 14 about the cell change. This way, according to the present invention, in a step 50, the SGSN 14 is informed (e.g., by the BSS 12 through the Gb interface) right after the MS (mobile station) 10 gets access on the target cell, which reduces the gap on the downlink transmission, because the cell update and flush procedures are eliminated as stated above, as shown in FIG. 3 (compare with the prior art FIG. 2 for the optimized intra-BSS procedure of 3GPP TS 43.129 V6.1.0 (2004-11)).

FIGS. 2 and 3 represent only one example for an optimized intra-BSS case. Furthermore, according to the present invention, a non-optimized intra-BSS case (SGSN controlled) and the inter-BSS case can be also optimized by omitting the cell update procedure. The inter-BSS case can include an intra SGSN case (e.g., a handover between cells of the BSS 12 and an additional BSS 20 communicating with the SGSN 14 as shown in FIG. 1) or an intra SGSN case (e.g., a handover between cells of the BSS 12 and a further BSS 24 communicating with a further SGSN 22 as shown in FIG. 1).

Also, according to the present invention, if steps 40, 42a and 42b are omitted an uplink transmission gap can be minimized as well. In the prior art a dummy LLC (logical link control) frame was frequently used to perform a cell update, thus minimizing the downlink transmission gap because the SGSN could start the downlink transmission sooner when a short LLC frame (e.g., the dummy LLC frame) was used for the cell update with faster handling of that short LLC frame. According to the present invention, sending the dummy LLC cell is not necessary any more and the mobile station 10 can send the LLC frame with a payload data right away after the PS handover is performed, thus minimizing the uplink transmission gap (e.g., in principle after step 38).

Thus, according to the present invention, the mobile station (MS) can be informed about said cell change in step 34 which allows starting immediately said uplink data transfer as discussed above, thus further reducing said service interruption caused by said packet switched handover.

The radio interface packet switched (PS) Handover Command message 34 shall contain an indication that a cell update is handled by the BSS 12, such that the MS 10 can omit the procedure and start the actual uplink data transmission right after access on the target cell.

For the optimized intra-BSS case a target BSC is the same as a source BSC so it knows based on the source and target cells whether the RA (routing area) stays the same or changes during the packet switched handover. For the optimized intra-BSS case the source and target cells are associated with the same network service entity (NSE) and the same routing area (RA).

For the non-optimized intra-BSS case and inter-BSS case the target BSC knows based on information elements a Source Cell Identifier and a Target Cell Identifier (inside a PS Handover Request from the SGSN 14 to the target BSS 12) whether the RA stays the same or changes during the packet switched handover. If the RA stays the same, the target BSC (e.g., the BSS 12, 20 or 24) shall handle the cell update towards the corresponding SGSN (e.g., the SGSN 14 or 22) and the MS 10 is informed. If the RA changes, it is up to the MS 10 to perform an RA update towards the SGSN 14 as currently defined in the standardization.

CS (circuit switched) type of Handover Performed message (per 3GPP TS 48.008 V6.7.0 (2004-11)) which is also called a PS Handover Performed message (as in the step 34 of FIGS. 2 and 3) could be used for to reducing the gap for a downlink data transmission.

For the optimized intra-BSS case, according to the present invention, with a message indicating the same as the BSSGP (base station subsystem GPRS protocol) Flush-LL-Ack message, data could be forwarded to the target cell and the source side radio resources could be released by the BSS 12 upon reception of the first correct uplink RLC/MAC (radio link control/medium access control) block (sent in a normal burst format) from the MS 10 (i.e., the uplink data reception from the MS 10 by the target cell triggers downlink data forwarding and releasing of the source side radio resources by the BSS 12).

According to the present invention, for the non-optimized intra-BSS case and the inter-BSS case the source side radio resources are still released by the SGSN, but the downlink data transmission gap is reduced by the omission of the cell update procedure as described above. The PS Handover Performed message (refer to step 50) shall therefore contain element information such as a TLLI (temporary logical link identity), a Cell Identifier (including RAC, i.e., routing area code), a Flush Action and a Number of Octets Affected. A new information element (for the target cell) “new BVCI” (BSSGP virtual connection identifier) is needed as well, if for the optimized intra-BSS case the message is not sent on the p-t-p (point-to-point) BVCI, but instead on the signalling BVCI.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method for improving the performance of a downlink data transfer during a packet switched handover, comprising:
changing a source cell to a target cell in a context of said packet switched handover; and
informing a serving general packet radio service (GPRS) support node about said cell change right after said change, which allows starting immediately said downlink data transfer, thus reducing a service interruption caused by said packet switched handover.

2. The method of claim 1 further comprising the step of:
informing a mobile station (MS) about said cell change right after said change, which allows starting immediately an uplink data transfer, thus further reducing said service interruption caused by said packet switched handover.

3. The method of claim 1, wherein said changing said source cell to said target cell is performed by a base station subsystem using a normal communication with a mobile station.

4. The method of claim 3, wherein said informing said serving general packet radio service (GPRS) support node about said cell change is performed by said base station subsystem, and after said informing said mobile station does not perform a cell update procedure.

5. The method of claim 4, wherein after informing said serving general packet radio service (GPRS) support node about said cell change, flush procedures are not performed.

6. The method of claim 1, wherein said informing is performed by a base station subsystem.

7. The method of claim 1, wherein said packet switched handover corresponds to an optimized intra-BSS procedure.

8. The method of claim 1, wherein said packet switched handover corresponds to a non-optimized intra-BSS procedure.

9. The method of claim 1, wherein said packet switched handover corresponds to an inter-BSS procedure.

10. The method of claim 1, wherein said packet switched handover is performed within a GSM/EDGE radio access network.

11. A computer program product comprising: a computer readable storage structure embodying computer program code thereon for execution by a computer processor with said computer program code characterized in that it includes instructions for performing the steps of the method of claim 2 indicated as being performed by any component or a combination of components of said base station subsystem, said mobile station, or said serving general packet radio service (GPRS) support node.

12. A system for improving the performance of a downlink data transfer during a packet switched handover, comprising:
a base station subsystem, for changing a source cell to a target cell in a context of said packet switched handover and for informing about said cell change right after said change; and
a serving general packet radio service (GPRS), responsive to said informing such that this allows starting immediately said downlink data transfer, thus reducing a service interruption caused by said packet switched handover.

13. The system of claim 12, wherein said changing said source cell to said target cell is performed by a base station subsystem using a normal communication with a mobile station.

14. The system of claim 13, wherein said informing said serving general packet radio service (GPRS) support node about said cell change is performed by said base station subsystem, and after said informing said mobile station does not perform a cell update procedure.

15. The system of claim 14, wherein after informing said serving general packet radio service (GPRS) support node about said cell change, flush procedures are not performed.

16. The system of claim 12, wherein said informing is performed by a base station subsystem.

17. The system of claim 12, wherein said packet switched handover corresponds to an optimized intra-BSS procedure or a non-optimized intra-BSS procedure.

18. The system of claim 12, wherein said packet switched handover corresponds to an inter-BSS procedure.

19. The system of claim 12, wherein said packet switched handover is performed within a GSM/EDGE radio access network.

20. A system of claim 12, wherein said base station subsystem is for further forwarding downlink data from the source cell to the target cell and for releasing radio resources in said source cell right after said cell change, which allows starting immediately said downlink data transfer, thus reducing said service interruption caused by said packet switched handover.

21. A base station subsystem for improving the performance of a downlink data transfer during a packet switched handover, comprising:
means for changing a source cell to a target cell in a frame of said packet switched handover;
means for informing a serving general packet radio service (GPRS) support node about said cell change right after said change, which allows starting immediately said downlink data transfer, thus reducing a service interruption caused by said packet switched handover.

22. A base station subsystem of claim 21, further comprising:
means for forwarding downlink data from the source cell to the target cell and for releasing radio resources in said source cell right after said cell change, which allows starting immediately said downlink data transfer, thus reducing said service interruption caused by said packet switched handover.
